(19) United States
(12) Patent Application Publication
(10) Pub. No.: US 2004/0206574 A1
(43) Pub. Date: Oct. 21, 2004

(54) Load lowering system

(76) Inventors: William H. Richey, Seattle, WA (US); John Bolding, Seattle, WA (US)

Correspondence Address: DEAN A. CRAINE, Ste. 140, 400 - 112th Ave. NE, Bellevue, WA, 98004, US

(21) Appl. No.: 10/672,214

(22) Filed: Sep. 25, 2003

Related U.S. Application Data
(60) Provisional application No. 60/413,968, filed on Sep. 26, 2002.

(51) Int. Cl. A62B 1/00

(52) U.S. Cl. 182/82

(57) ABSTRACT

A system for mechanically lowering a load from an elevated position to a lower position in a relatively slow and controlled manner using only gravity and frictional forces. The system includes a vertically aligned glide rod, a guide collar that moves longitudinally over the glide rod, two vertically mounted friction rods mounted on opposite sides of the glide rod, a friction collar that moves longitudinally along each friction rod, and a support platform coupled to each friction collar and to the guide collar. The glide rod includes spiral fluted vanes along its entire length upon which the guide collar rides when a load placed on the support platform, allowing the support platform to descend at a safe speed via gravity. The friction rod and collars are used to move the support platform from a stored position located above the elevated loading position to a lower position so that a load may be placed onto the support platform and to stabilize the support platform as it descends from the loading position to the ground.

This utility patent application claims the benefit of provisional patent application (Ser. No. 60/413,968) filed on Sep. 26, 2002.

### BACKGROUND OF THE INVENTION

1. Field of the Invention

This invention relates to systems used to lower a load from an elevated location to a lower location, and more particularly, for such systems that include a platform that moves in a slow, controlled manner.

2. Description of the Related Art

Exterior mounted fire escape systems that allow residents in the building to escape during a fire or emergency situation in the building are well known. One type of system includes a motor-driven carriage that moves over a rail vertically mounted on the outside of the building. One drawback with such systems is that the movement of the carriage is dependent upon a constant supply of electricity to operate the motor. Another drawback with such systems is that they are relatively complex and use an electric motor and switches that require connection to the building electrical circuits.

### SUMMARY OF THE INVENTION

It is an object of the present invention to provide a load lowering system that can be installed on the side of a building and used as a fire or emergency escape system for residents in the building.

It is another object of the present invention to provide such a system that is mechanically operated and does not require the use of electricity.

These and other objects of the present invention are met by a system for mechanically lowering a fragile load from an elevated position to a lower position in a relatively slow and controlled manner. The system is specifically described as a fire escape system mounted on the exterior wall of a building. It should be understood, however, that the system may be used in other applications where it is desirable to move a load in a relatively slow controlled manner.

The system includes a vertically aligned glide rod, a guide collar that moves longitudinally over the glide rod, at least one vertically mounted guide means mounted on the exterior wall and adjacent to the glide rod for controlling the movement of the guide collar over the glide rod, and a support platform coupled to the guide collar.. In the preferred embodiment, the system also includes two vertically aligned friction rods mounted on opposite sides of the glide rod to the exterior wall of the building, and a friction collar that moves longitudinally over each friction rod.

The glide rod includes a continuous spiral groove located between a laterally extending spiral vane. The guide collar includes a non-rotating upper bearing plate securely attached to the bottom surface of the support platform and a lower bearing plate member that rotates around the glide rod. Roller or ball bearings are disposed between the upper bearing plate and the lower bearing plate so that the weight of a load placed on the support platform is transferred to the lower plate member. Attached to the lower bearing plate are two pivoting vane engaging plates that extend inward and slide over the top surface of the vane as the lower bearing plate descends over the guide rod. As the lower bearing plate descends on the guide rod, it rotates while the upper bearing plate remains stationary so that cargo loaded thereon does not rotate. The diameter of the guide rod, the pitch of the groove and the angle of the vane set at a desired amount so that the support platform descends slowly on the glide rod when transporting a load to the ground.

During assembly, the two friction rods and the glide rod are vertically aligned and mounted on the vertical sides of a building. The two friction rods vary in diameter along their lengths which increases and decreases the force applied by the friction collar as it descends on the friction rod. Each friction collar includes means for adjusting the amount of friction exerted on the friction rod so that the rate of descent of the friction collars may be controlled for a specific amount of load weight. The friction collars are attached to a support platform upon which the load to be lowered is placed. The diameter of the friction rods varies at different locations along the friction rod to change the rate of descent over the friction rod. More specifically, the friction collars are used to slow the descent of the support platform from a stored position located above the loading site to the loading site and slow the descent of the support platform from the loading site to the ground. The friction rods are also used secondarily to stabilize the support platform as it descends from the loading site to the ground.

An optional storage assembly is provided for storing the support platform in a raised position above the loading site. An optional re-lift cable and pulleys are provided for raising the support platform from the ground to the loading site or to the stored position.

### DESCRIPTION OF THE DRAWINGS

FIGS. 1A-K are side elevational views of a building showing the sequential movement of the load lowering system installed on the sides of the building and being used by a family to escape from an elevator escape loading site.

FIG. 2 is a top plan view of the lower frame.

FIG. 3 is a front elevational view of the carriage.

FIG. 4 is a front elevational view of a section of the glide rod.

FIG. 5 is a front elevational view of the lower frame showing the support plate, the upper bearing plate, and lower bearing plate mounted on the glide rod.

FIG. 6 is a top plan view of the upper bearing plate.

FIG. 7 is a top plan view of the lower bearing plate.

FIG. 8. is a side elevational view of the lower bearing plate shown in FIG. 7.

FIG. 9 is a side elevational view of the friction rod.

FIG. 10 is a side elevational view of a friction collar.

FIG. 11 is a top plan view of the friction collar.

FIG. 12 is a front elevational view of the carriage showing the release lever.

FIG. 13 is a top plan view of the top frame.

FIG. 14 is a top plan view of the upper bracket used to temporarily hold the friction

FIG. 15 is side elevational view of the upper bracket.

FIG. 16 is a front elevational view showing the upper and lower frame assemblies in a stored position.

FIG. 17 is a side elevational view of the upper and lower frame assemblies in a stored position.

### DESCRIPTION OF THE PREFERRED EMBODIMENT(S)

Shown in the 1A-1K is a system 6 for mechanically lowering a load from an elevated position to a lower, unloading position in a relatively slow and controlled manner. The system 6, which is specifically designed not to require electricity, includes a carriage 7 designed to carry load that is initially stored in an elevated storage location above an escape opening 94 formed on the walls 91 of a building 90. When an emergency exist that requires a user in the upper floor of a building 90 to quickly leave the building 90, the carriage 7 descends to the escape opening 94. The user then uses the escape opening 94 and enters the carriage 7. The carriage 7 then slowly descends to the ground where the user departs. The carriage 7 is then returns to the escape opening 94 to pick up additional users. The key feature of the system 6 is that it is mechanical and does not require electricity and always lowers the user at a safe, constant rate regardless of his or her weight.

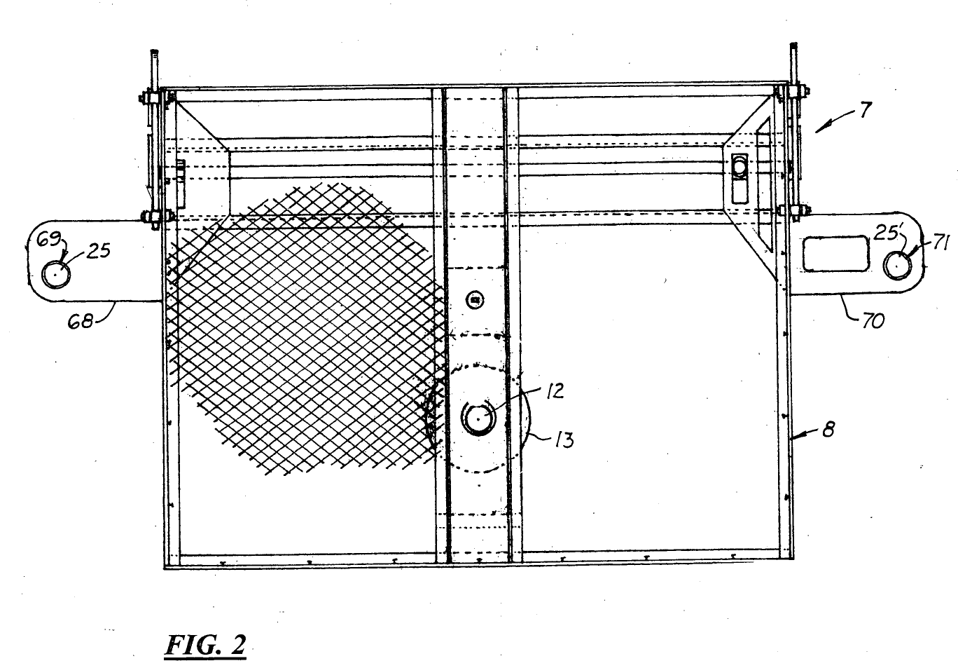

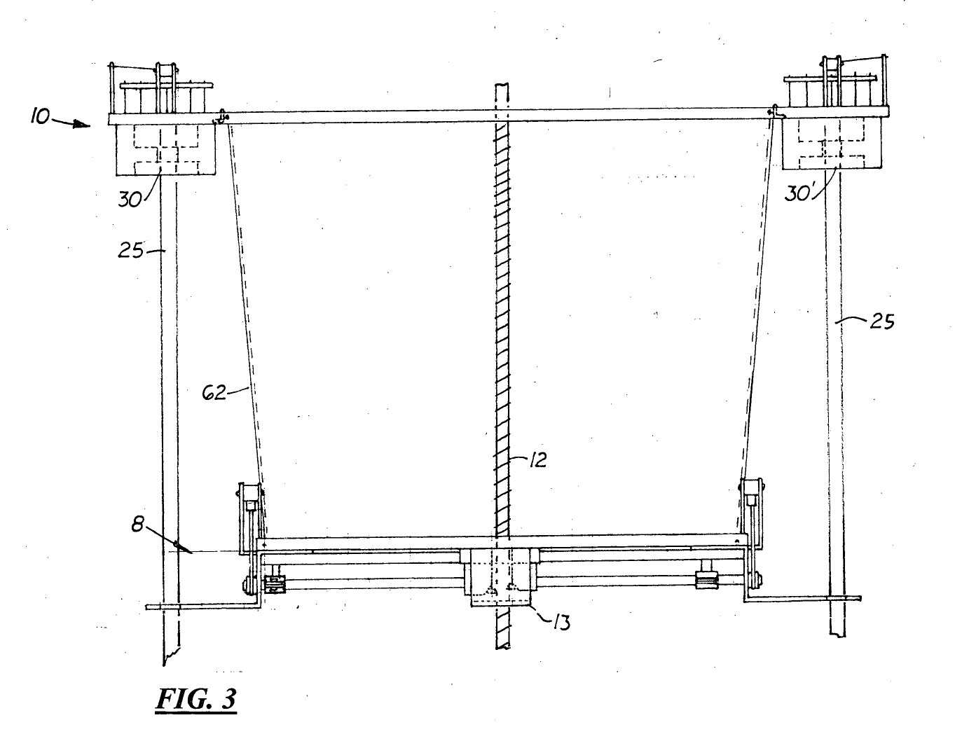

The carriage 7, which is shown more clearly in FIGS. 2 and 3, includes a lower frame assembly 8, an upper frame assembly 10 and a three-sided, flexible canopy 62. The lower frame assembly 8 rides on a glide rod 12 mounted on the exterior wall 91 of a building 90. Assembled on opposite sides of the glide rod 12 are two vertically mounted friction rods 25, 25′ that are engaged by the upper frame assembly 10. The lower frame assembly 8 includes a guide collar 13 that travels over the glide rod 12. The upper frame assembly 10 includes two friction collars 30, 30′ that travel over the two friction rods 25, 25′, respectively.

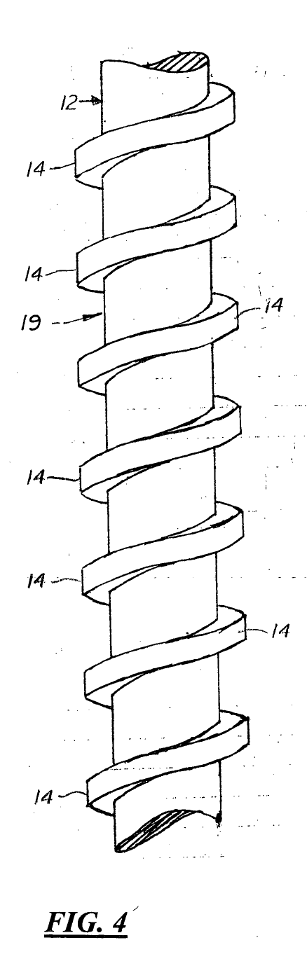

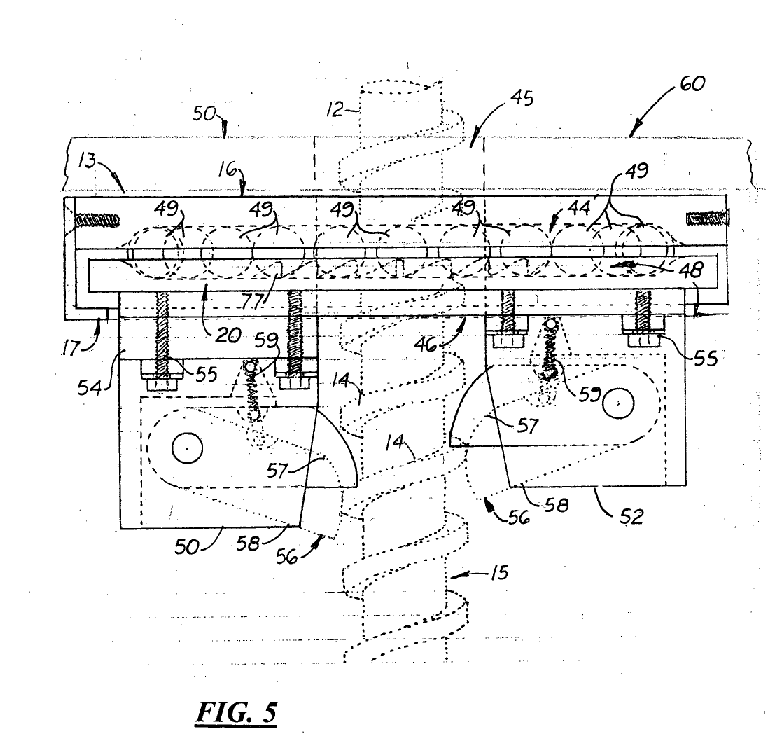

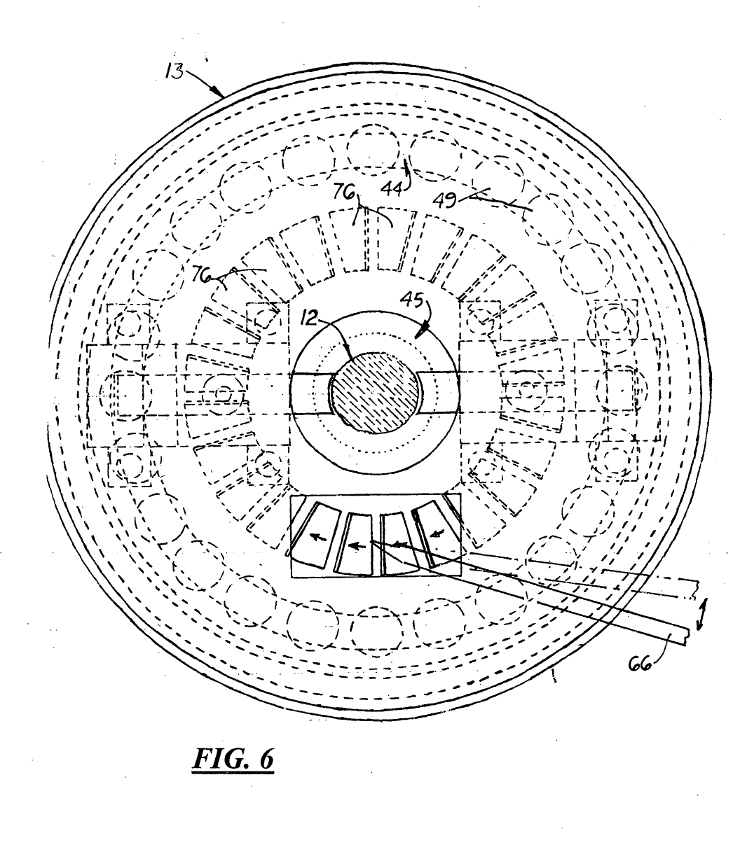

As shown in FIG. 4, the glide rod 12 includes a continuous helical groove 15 separated by a laterally extending spiral vane 14. During operation, a guide collar 13 rides over the vane 14 when a load is placed on the support platform 60 attached to the lower frame assembly 8. As shown more clearly in FIGS. 5 and 6, the guide collar 13 includes an upper bearing plate 16 securely attached to the bottom surface of the support platform 60. The upper bearing plate 16 is a flat circular structure with a circular bearing raceway 44 formed on its lower surface. Formed centrally on the upper bearing plate 16 is a circular opening 45 through which the guide rod 12 extends. Securely attached to the perimeter of the upper bearing plate 16 is a downward extending retaining ring 17 designed to hold the lower bearing plate 20 under the upper bearing plate 16.

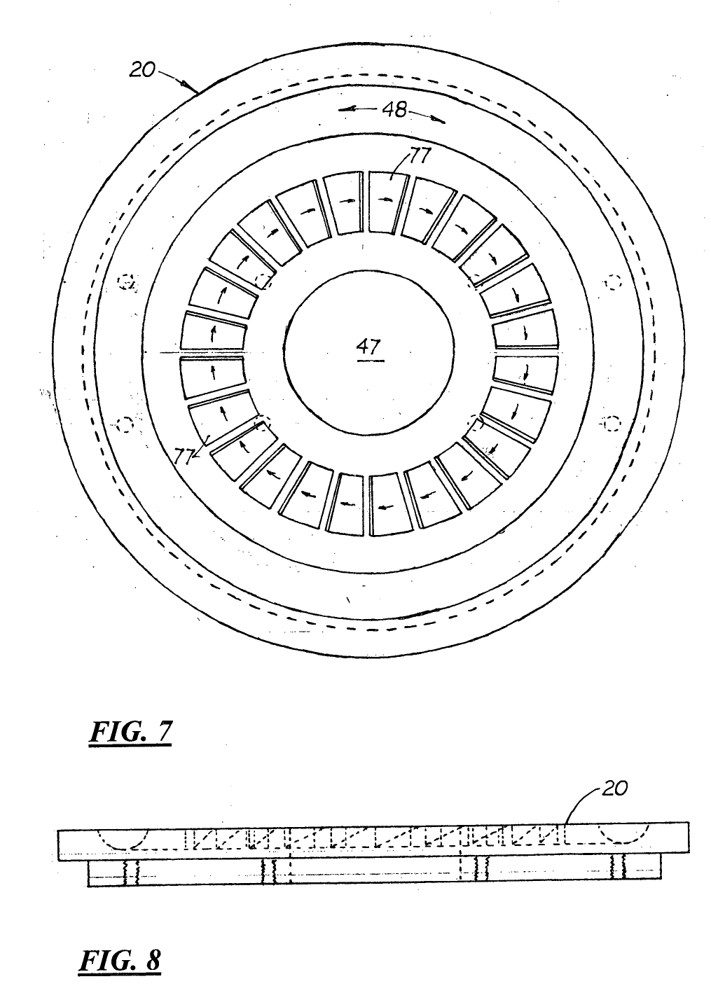

As shown in FIGS. 5, 7, and 8, the lower bearing plate 20 is a flat, circular structure with a central opening 47 which is aligned and registered with the circular opening 45 formed on the upper bearing plate 16. The lower bearing plate 20 is slightly smaller in diameter than the upper bearing plate 16 so that it may rotate freely inside the retaining ring 17. The guide rod 12 extends through both openings 45, 46 on the upper and lower bearing plates 16, 20, respectively.

Formed on the top surface of the lower bearing plate 20 near the perimeter edge is a lower circular raceway 48 which is aligned and registered with the upper raceway 44 formed on the upper bearing plate 16. Disposed inside the two raceways 44, 48 are a plurality of rollers or ball-bearings 49. Formed on the opposing inside surfaces of the two circular raceways 44, 48 are two set of inclined teeth 76, 77, respectively. The two sets of inclined teeth 76, 77 are arranged in a circular pattern and coaxing aligned with the central openings 45, 47. During assembly, the sets of inclined teeth 76, 77 are meshed together to prevent rotation of the lower bearing plate 20 in a counter-clockwise direction with respect to the upper guide plate 16. Formed on the upper bearing plate 16 is an optional opening 19 in which a lever bar 66 is inserted. As shown in FIG. 6, the tip of the lever bar 66 is inserted into the opening 19 and used to pry the sets of incline teeth 76, 77 apart thereby causing the lower bearing plate 20 to rotate under the upper guide plate 16.

Referring to FIG. 5, attached to the lower surface of the lower bearing plate 20 on opposite sides of the central opening 47 are two downward extending brackets 50, 52. Attached to one bracket (bracket 50) is a spacer block 54 used to position the bracket 50 at a lower position on the guide rod 12 than the opposite bracket 52. Suitable threaded bolts 55 are used to attach the two brackets 50, 52 and spacer block 54 to the lower bearing plate 20. Pivotally attached to each bracket 50, 52, is an inward extending guide point 56. In the preferred embodiment, each guide point 56 is an elongated structure with curved upper edge 57 and a straight lower edge 58. During use, the lower edge 58 travels over the top surface of the vane 14 on the glide rod 12. The tip of the guide point 56 is pointed to engage the groove 15 formed on the guide rod 12. Disposed between each guide point 56 and the lower surface of the lower bearing plate 20 is a spring 59 that bias the guide point 56 in an upward direction. When the support platform 60 is raised on the guide rod 12, the two guide points 56, 56′ pivot downward and disengage from the groove 15.

As shown in FIG. 2 and 3, attached to the sides of the support platform 60 are two laterally extending guide brackets 68, 70 that surround and engage the two friction rods 25, 25′ located on opposite sides of the glide rod 12. Each guide bracket 68, 70 includes a bore 69, 71 that receives the adjacent friction rod 25, or 25′. During use, the brackets 68, 70 help stabilize the support platform 60 as it moves along the guide rod 12.

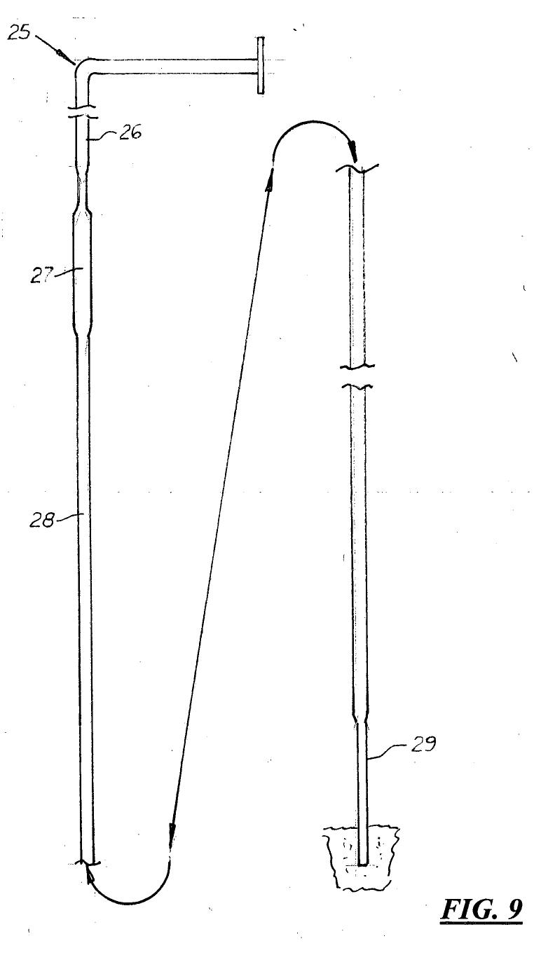

As mentioned above, the system 10 uses two friction rods 25, 25′ and two friction collars 30, 30′ that are used to lower the support platform 60 from a stored position to the loading position. As shown in FIG. 9, the friction rods 25, 25′ are vertically aligned and fixed at their upper ends to an upper bracket attached to the wall 91 at a location above the loading position. Each friction rod 25, 25′ includes different diameter sections 26, 27, 28, and 29 that gradually taper from one diameter to another along the entire length.

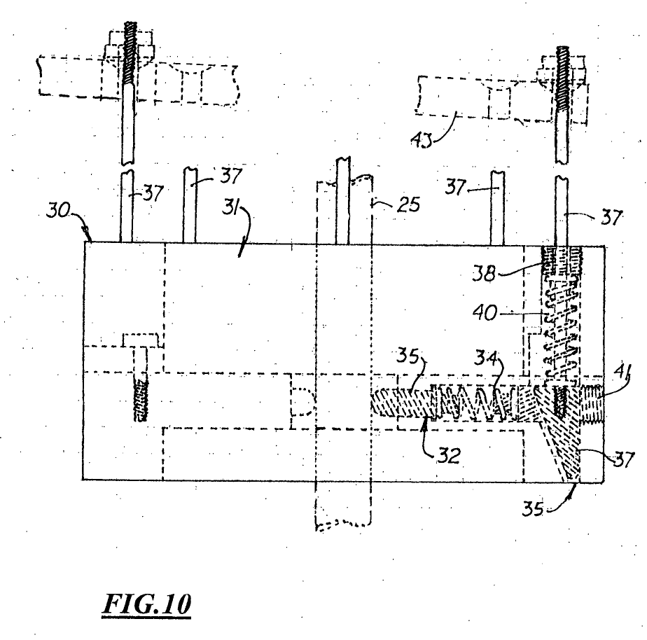

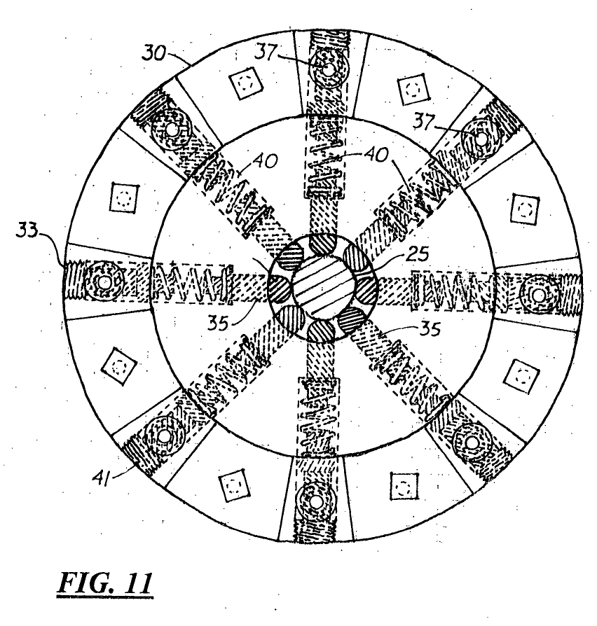

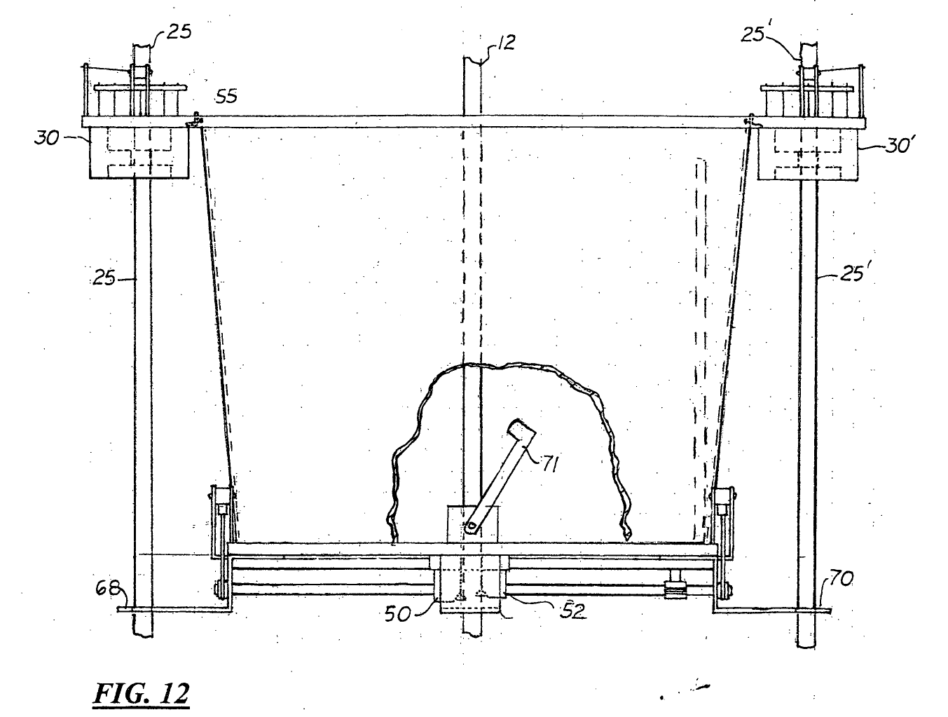

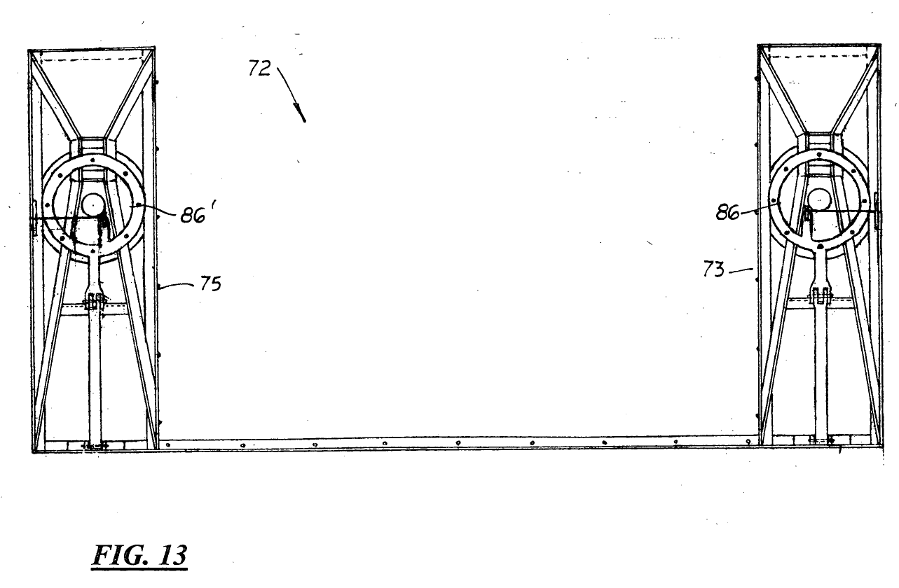

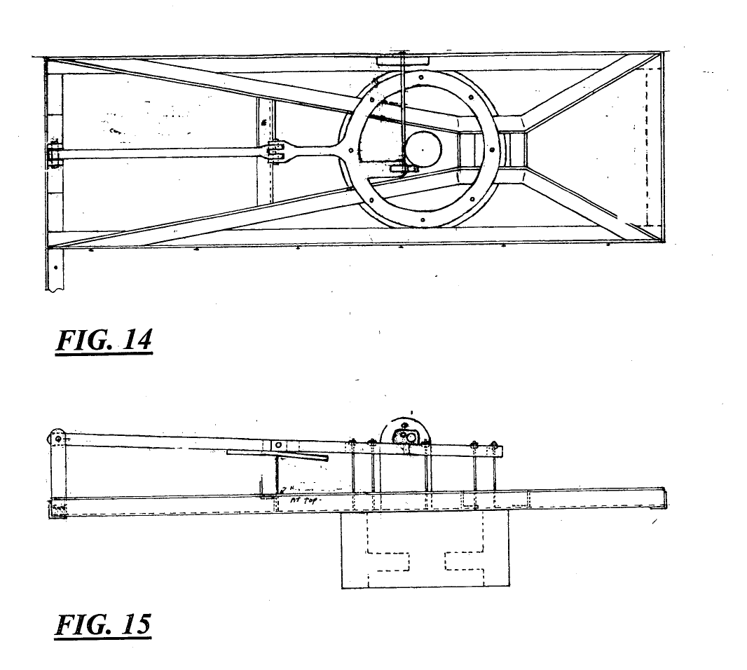

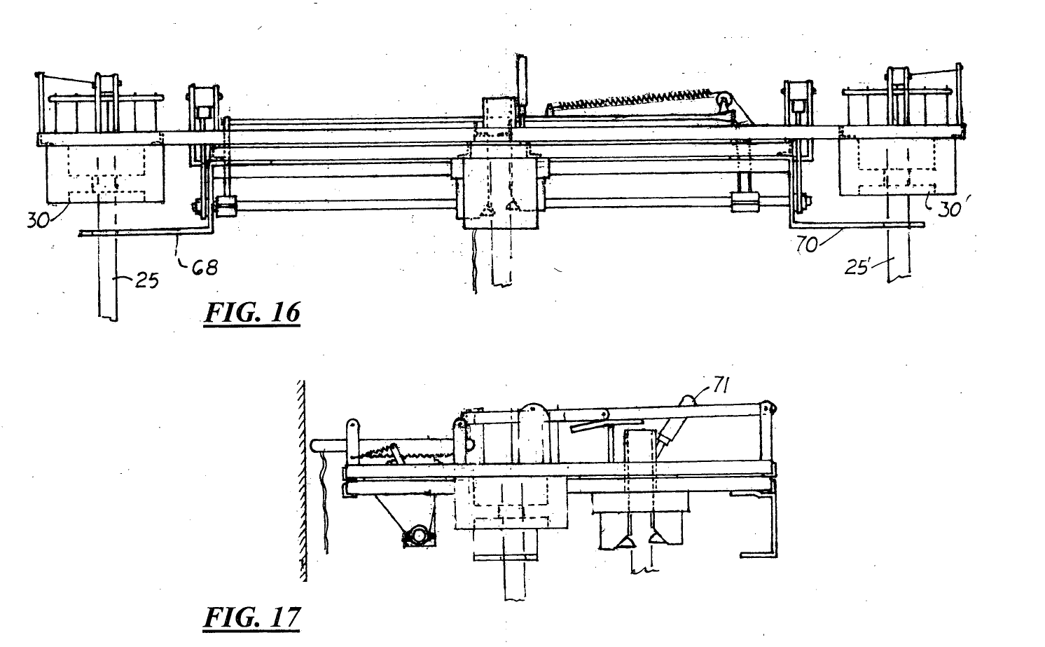

The two friction collars 30, 30′ are mounted on opposite sides of the upper frame assembly 10 located above the support platform 60. As shown in FIGS. 10 and 11, each friction collar 30 includes a center bore 31 designed to receive a friction rod 25. Aligned transversely on each friction collar 30 are at least two adjustable spring-loaded plungers 32. Each plunger 32 fits inside a transversely aligned passageway 33 formed on the collar 30. Each plunger 32 includes an internal spring 34 that forces an inward extending friction point 35 through the passageway 33 and against the inside surface of the friction rod 25. In the preferred embodiment, each friction collar 30, 30′ includes twelve, radially aligned spring-loaded plungers 32.

Formed near the perimeter edge of each friction collar 30, 30′ is a wedge-shaped passageway 35 with a converting section designed to receive a wedge-shaped control pin 37. The control pin 37 includes a threaded nut 38 located at one end and a wedge body 39 located at its opposite end. A spring 40 is disposed around the pin 37 and used to force the wedge body 39 into the wedge-shaped passageway 36. The plunger 32 is connected to a plunger nut 41 that contacts the sides of the wedge body 39. By adjusting the length of the control pin 37 inserted into the passageway 36, the amount of force applied by the friction point 35 against the side of the friction rod 25 may be adjusted. A control lever 43 is used to control the length of the control pins 37 used with each plunger 32.

During operation, each friction collar 30, 30′ slides longitudinally over the friction rod 25 and travels over the different diameter sections 26, 27, 28, and 29 . The frictional resistance of the friction collar 30 as it passes over the different diameter sections 26, 27, 28, and 29, is a function of the internal spring located inside each plunger 32. As the friction collar 30, 30′ passes over the friction rods 25, 25′ the frictional resistance of the friction collar 30, 30′ over the friction rods 25, 25′ depends on the biasing pressure exerted by the springs 32 on the friction points 36, 36′. During assembly, the amount of pressure exerted by the spring 34 on the plunger 32 is adjusted so that the friction collars 30, 30′ slide slowly over the wide sections 26, 27, 28, 29 and freely over the narrow sections. During use, the amount of pressure exerted by the friction points 36 may be selectively adjusted for less or greater load weights. When the gravitational forces on the support platform 60 exceed the frictional forces exerted by both friction collar 30, 30′ on the two friction rods 25, 25′, the support platform 60 descends. When the frictional resistance of the friction collar 30, 30″ exceeds the gravitational forces on the support platform 60, the friction collar 30, 30′ slows and gradually stops.

When the system 6 is used with an emergency building escape opening 94, the lower frame assembly 8 and upper frame assembly 10 are stored in an optional storage frame assembly 72 located above the escape opening 94. As shown in FIG. 13, the storage frame assembly 72 includes two side brackets 73, 75 that extend perpendicularly from the wall of the building 90. When a release lever 78 located adjacent to the escape opening 64 is activated, the support platform 60 begins to slowly descend.

The lower ends of the friction rods and guide rod 12 are embedded in cement footings constructed on the landing site while the upper ends of the friction rods 25, 25′ and guide rod 12 are attached to upper brackets 85, 85′ that extend outward from the walls of the building. The two brackets 85, 85′ which are used to hold the friction rods 25, 25′, respectively, each include a locking assembly 86′ that temporarily holds the friction collar 30, 30′ in a locked position on the upper end of the friction rod 25, 25′. When the locking assembly 86 is released, the friction collar 30, 30″ are allowed to descend over the friction rods 25, 25′, respectively. An optional canopy 11 may be assembled between the lower frame assembly 8 and the upper frame assembly 10 to restrain a load placed on support platform 60 and to provide comfort.

During use, the carriage 7 is raised to a stored, collapsed position above a building escape hatch 94. When needed, a hatch release line is pulled to release the carriage 7 from the storage assembly. As the support platform 60 descends to the escape hatch 94, the canopy 62 expands to form a partially enclosed carrier to the user. After loading onto the support platform 60, a second release handle 71 is then released to allow the support platform 60 to slowly descend to the ground.

As stated above, the friction collar 30, 30′ and friction rod 25, 25′ are well suited for deployment of the support platform 60 from an elevated, collapsed stored position located above an escape hatch 94. However, since the friction collars 30, 30′ is not sensitive to load weight variation or loading eccentricity, they are not well suited to control the descend of the support platform 60 from the escape hatch 94 to the ground. Since the guide collar 13 and glide rod 12 are sensitive to live load weight variations, they may be used to control descend of the support platform 60 from the escape hatch 94 loading position to the ground.

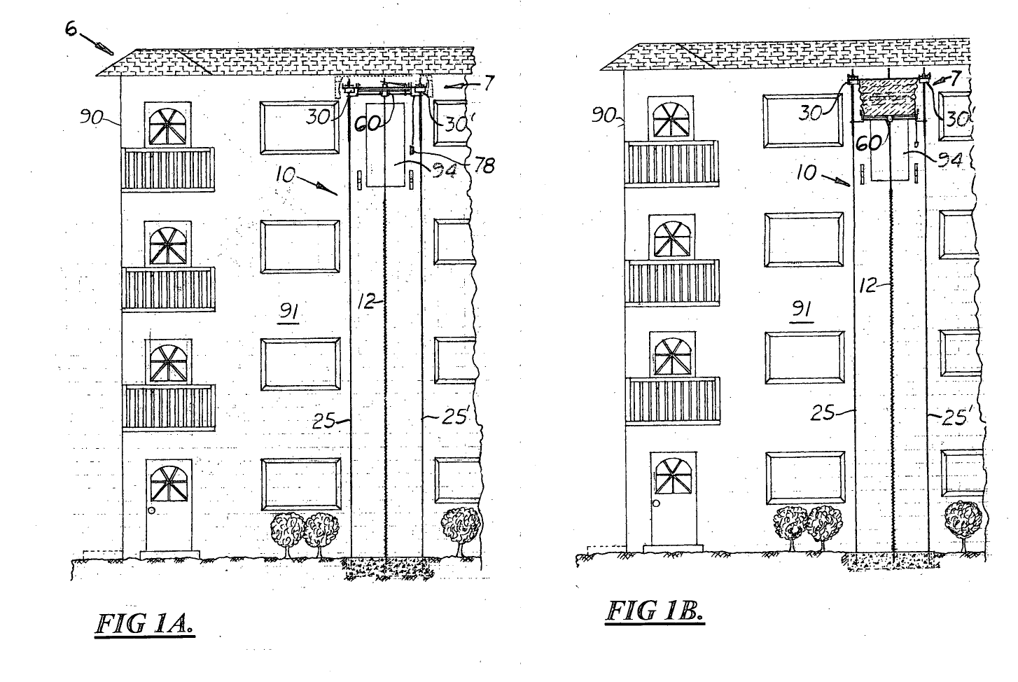

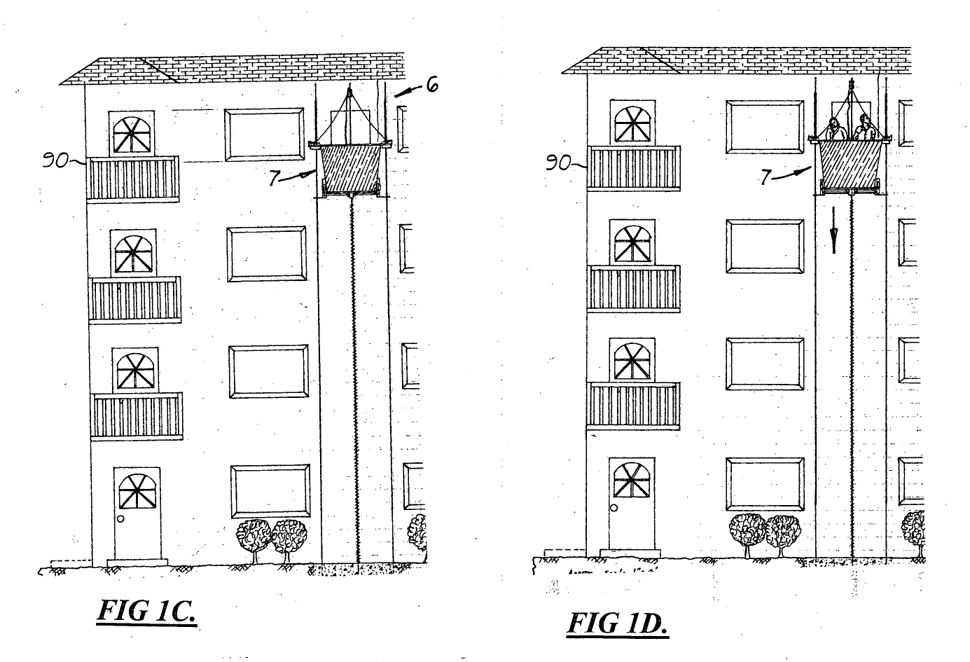

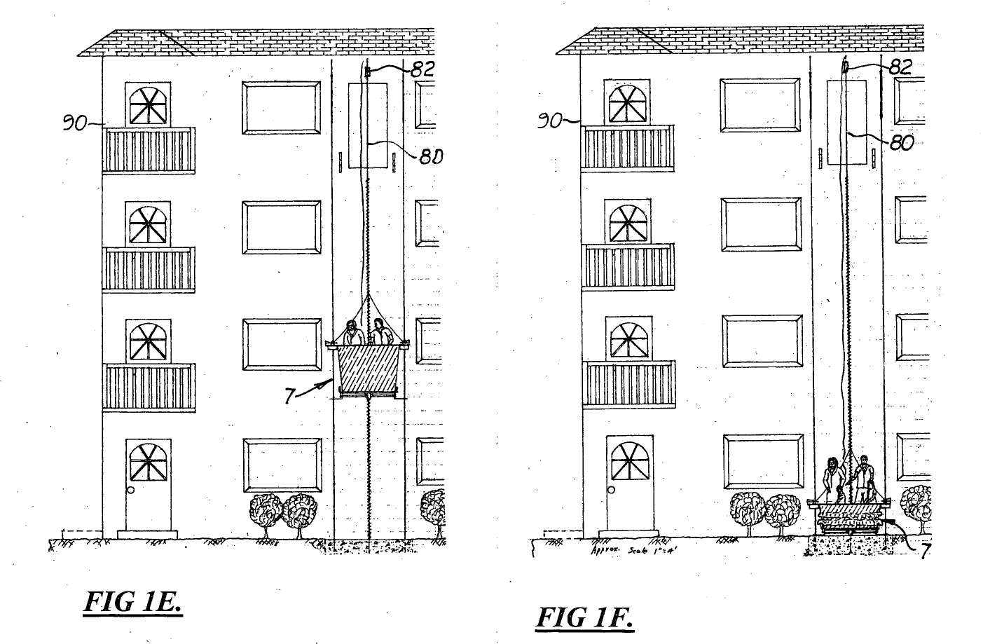

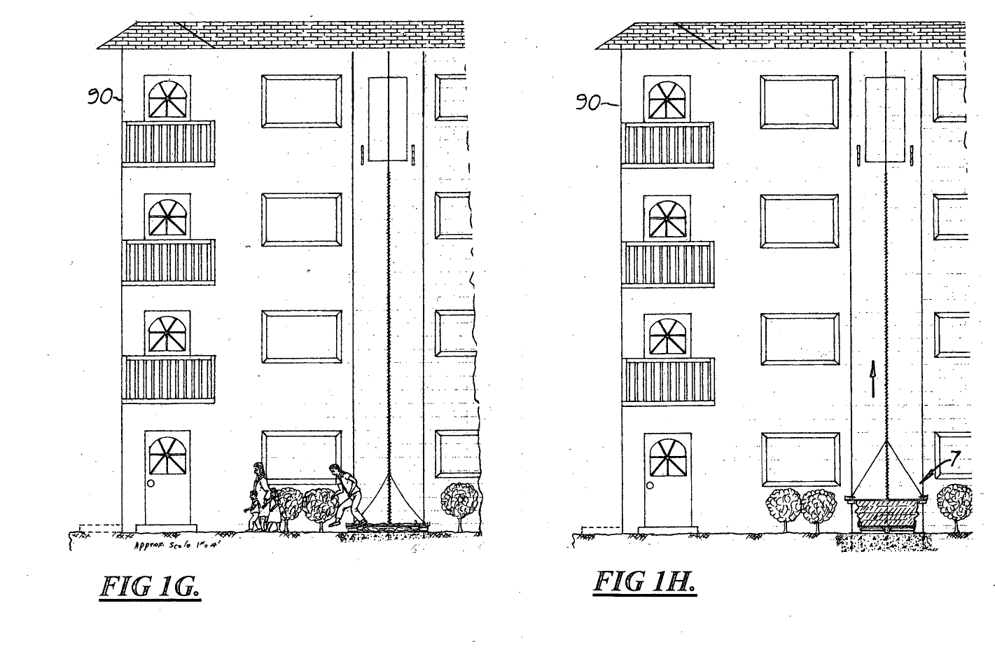

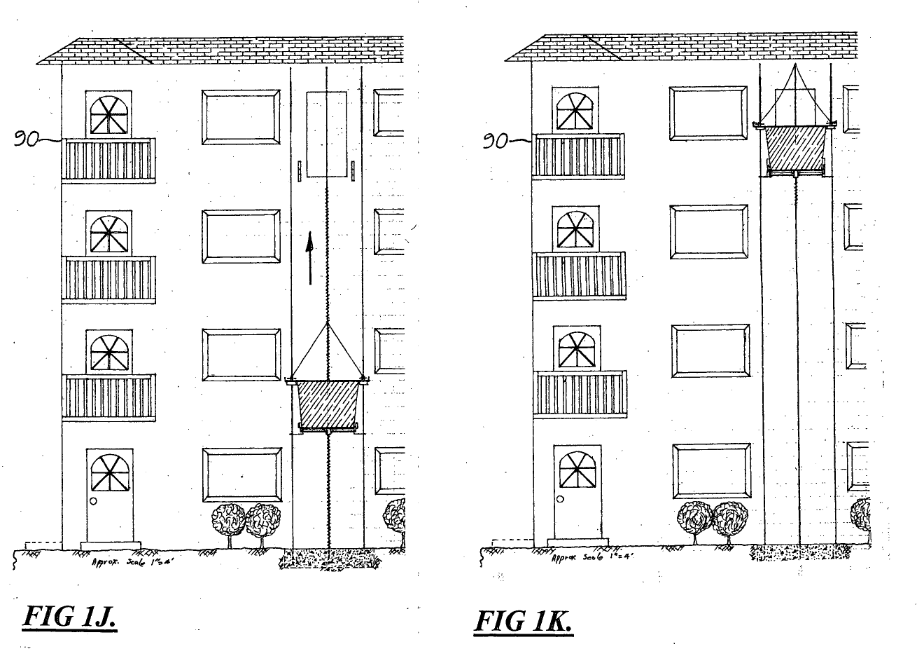

Also shown in FIGS. 1A-K, is an optional re-lift cable 80 for raising the support platform 60 from the ground to the escape hatch 94 and to the stored position. In the preferred embodiment, the re-lift cable 80 is mounted on a pulley 82 located between the upper frame members 55. A hatch release line 84 extends from the escape hatch 94 to the pulley 82 which, when activated, releases the support platform 60 and allows it to descend from the stored position to the escape hatch 94. The re-lift cable 80 is sufficient in length to allow the user to reach the end of the re-lift cable 80 when standing on the ground.

In the preferred embodiment, the guide rod 12 and friction rods 25, 25′ are approximately 1 to 2 inches in diameter and made of steel or aluminum. The guide collar and friction collars are also made of steel or aluminum and 6 to 10 inches in diameter. The support platform 60 is a circular plate designed to connect to the top surface of the upper bearing plate 16. In the preferred embodiment, the support platform 60 measures approximately 36 inches in diameter. The pitch of the vanes on the guide rod 12 is sufficient so that the support platform 60 descends 1 to 3 inches for each revolution of the lower bearing plate.

### Operation

As stated above, the support platform 60 is located in the stored, low profile position above the escape hatch 94. When the hatch release line 84 is pulled the support platform 60 slowly descends from the stored position towards the escape hatch 94. As the support platform 60 descends, the movement of the upper frame assembly 10 is momentary restrained by the locking assembly 86 while the lower frame assembly 8 descends freely. The canopy 62, disposed between the two frame assemblies 8, 10 slowly unfolds thereby creating a three-sided enclosure.

As the support platform 60 descends towards the escape hatch 94 it contacts clips 64 located adjacent to the escape hatch 94, the clips 64 block further descent of the support platform 60 on the rods 12, 25, 25′. The passengers may then move through the escape hatch 94 and onto the support platform 60. The passengers then activate the release handle 70, which disengages the support platform 60 from the clips 64 thereby allowing the support platform 60 to descend. Because the weight of the support platform 60 and the passengers exceeds the frictional forces on the friction rods 25, 25′, the support platform 60 begins to slowly descend.

When the support platform 60 nears the unloading ground or area, the diameter of the friction rods 25, 25′ gradually increases thereby increasing the amount of frictional forces exerted by the frictional collars 30, 30′ on the friction rods 25, 25′, respectively. Gradually the support platform 60 comes to a stop when the frictional forces exceed the force of gravity.

When the support platform 60 reaches the ground or unloading area, the upper frame assembly 10 continues to descend thereby lowering the canopy 60 so that the passengers may easily walk off the support platform 60.

When the support platform 60 is in the collapsed position, the re-lift cable 80 is used to lift the support platform 60 to the escape hatch 94 or to the original stored location. When the support platform 60 reaches the loading position, lifted slightly above the escape hatch, the clips 64 are re-engaged. The support platform 60, may then lifted to the stored position and pre-engages the storage assembly.

In compliance with the statute, the invention described herein has been described in language more or less specific as to structural features. It should be understood, however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

We claim:

1. A load lowering system, comprising:
a. at least one friction rod vertically mounted on a building;
b. a friction collar disposed around said friction rod;
c. means for creating a friction force between said friction collar and said friction rod that resists movement of said friction collar over said friction rod;
d. at least one glide rod vertically mounted on a building, said glide rod being spaced apart from and parallel to said friction rod, said glide rod including a helical thread formed thereon;
e. a guide collar disposed around said glide rod, said guide collar including means for engaging said thread on said guide rod 12 thereby causing said glide rod to rotate as said glide collar travels over said glide rod; and,
e. a support platform disposed perpendicularly to said friction rod and said glide rod, said support platform being supported by said friction collar when attached to said friction rod and by said guide collar when attached to said guide rod.

2. The load lowering system, as recited in claim 1, wherein said means for creating the amount of friction force is a plurality of biased friction points on said friction collar that press against said friction rod.

3. The load lowering system, as recited in claim 2, wherein said friction collar includes means for adjusting the amount of friction force between said friction force between said friction collar and said friction rod.

4. The load lowering system, as recited in claim 3, wherein said means for adjusting the amount of friction forces are adjustment screws that adjust the amount of biasing forces extended by said friction points.

5. The load lowering system, as recited in claim 2, wherein said friction rod varies in diameter along its length.

6. The load lowering system, as recited in claim 3, wherein said friction rod varies in diameter along its length.

7. The load lowering system, as recited in claim 1, wherein said guide collar includes an upper bearing plate securely attached to said support platform and a rotating lower bearing plate that rotates around said glide rod when said guide collar moves longitudinally over said glide rod.

8. The load lowering system, as recited in claim 7, wherein said friction collar includes means for adjusting the amount of friction force exerted by said means for creating friction force between said friction collar and said friction rod.

9. The load lowering system, as recited in claim 8, wherein said friction collar includes means for adjusting the amount of friction force exerted by said friction collar on said friction rod.

10. The load lowering system, as recited in claim 9, wherein said friction rod varies in diameter along its length.

11. The load lowering system, as recited in claim 7, further including a set of bearings disposed between said upper bearing plate and said lower bearing plate enabling said lower bearing plate to rotate relative to said upper-bearing plate.

12. The load lowering system, as recited in claim 8, further including a set of bearings disposed between said upper bearing plate and said lower bearing plate.

13. The load lowering system, as recited in claim 1 1, further including at least one vane guide plate attached to said lower bearing plate that slides over said vanes on said glide rod as said guide collar moves longitudinally over said glide rod.

14. The load lowering system, as recited in claim 12 further including at least one vane guide plate attached to said lower bearing plate that slides over said vanes on said glide rod as said guide collar moves longitudinally over said glide rod.

15. The load lowering system, as recited in claim 1 further including a collapsible canopy attached to said support platform.

16. The load lowering system, as recited in claim 15 further including an upper frame member located above said support platform that attaches to said collapsible canopy to unfold said canopy when said support platform moves from a stored position to a loading position.

17. The load lowering system, as recited in claim 3 further including a canopy attached to said platform.

18. The load lowering system, as recited in claim 1 further including a bracket attached to each said friction rod for holding said support platform in a stored raised position when not in use.

19. The load lowering system, as recited in claim 17, further including a release lever coupled to said support platform to disengage said support platform from said bracket to allow said support platform to descend over said friction rod and said guide rod to a loading position.

20. The load lowering system, as recited in claim 18, further including a cable attached to said support platform used to raise said support platform on said friction rod and said guide rod.
